(19) United States
(12) Patent Application Publication
(10) Pub. No.: US 2015/0348134 A1
(43) Pub. Date: Dec. 3, 2015

(54) Predicting the Performance of an Advertising Campaign

(71) Applicant: FACEBOOK, INC., Menlo Park, CA (US)

(72) Inventors: Xiaohu Jiang, Palo Alto, CA (US); Dan Zhang, Foster City, CA (US); Wenjie Fu, Foster City, CA (US); Linji Yang, Menlo Park, CA (US); Spencer Powell, San Francisco, CA (US)

(73) Assignee: FACEBOOK, INC., Menlo Park, CA (US)

(21) Appl. No.: 14/292,277

(22) Filed: May 30, 2014

(51) Int. Cl. G06Q 30/02; G06Q 50/00

(52) U.S. Cl. CPC G06Q 30/0275; G06Q 50/01

(57) ABSTRACT

An advertiser specifies an advertising campaign including one or more targeting criteria for presentation to users of an online system, which retrieves information describing previously completed advertisement auctions for presenting advertisement to users of the online system satisfying one or more of the targeting criteria. Based on the retrieved information, the online system associates various bid amounts with the advertising campaign and determines the advertising campaign's estimated performance for various bid amounts. For each bid amount, the online system determines a number of previously completed advertisement auctions that would have selected an advertisement from the advertising campaign, an amount that would have been charged to the advertiser if an advertisement campaign was selected, and a number of distinct users that would have been presented with an advertisement from the advertising campaign.

### BACKGROUND

This disclosure relates generally to online advertising, and more specifically to predicting a reach or budget of an online advertising campaign.

Advertisers may have certain goals when planning a new advertising campaign (“advertising campaign”). For instance, an advertiser may have a goal for the number of times an advertisement is presented to users of an online system (i.e., the number of “impressions” of the advertisement), the number of different online system users presented with an advertisement (i.e., the “reach” of the advertisement), and/or a duration during which the advertisement is presented. Conventionally, an advertiser specifies certain attributes of an advertising campaign or advertisements in an advertising campaign when specifying the advertising campaign. For example, an advertiser identifies targeting criteria associated with one or more advertisements in an advertising campaign.

However, advertisers may lack information to accurately identify how to achieve one or more goals of an advertising campaign. For instance, an advertiser may have a desired reach for an advertisement campaign, but lack information for determining a budget to achieve the desired reach or lack information for specifying bid amounts of advertisements in the advertising campaign to achieve the desired reach. Alternatively, an advertiser may specify a budget for an advertising campaign, but lack information for determining an amount of reach capable of being achieved with the budget or lack information for determining bid amounts for advertisements included in the advertising campaign that would increase the reach of the advertising campaign.

### SUMMARY

A social networking system determines a predicted performance of an advertising campaign received from an advertiser based on information about previously completed advertisement auctions performed by the social networking system to select advertisements for presentation to users and information provided by the advertiser. Using information describing previously completed advertisement auctions allows the social networking system to estimate performance of the advertising campaign in presenting advertisements to social networking system users. For example, a predicted number of impressions for an advertising campaign is determined based on the information describing advertisement auctions previously completed by the social networking system.

When predicting performance of the advertising campaign, the social networking system determines a predicted performance of the advertising campaign for multiple bid amounts associated with advertisements in the advertising campaign. For each bid amount, the social networking system determines a number of impressions, an amount of reach and/or a budget that would be achieved using the bid amount and the information describing previously completed advertisement auctions. As an example, the social networking system associates different bid amounts with advertisements in the advertising campaign and determines a number of previously completed advertisement auctions in which an advertisement from the advertising campaign would have been selected using each of the bid amounts. The social networking system also determines a number of advertisement auctions associated with distinct users in which an advertisement from the advertising campaign would have been selected for different bid amounts associated with advertisements from the advertising campaign. This determines a predicted amount of reach for the advertising campaign for different bid amounts associated with advertisements in the advertising campaign. For previously completed advertisement auctions in which an advertisement from the advertising campaign would have been selected when associated with a bid amount, the social networking system also determines an amount charged to an advertiser associated with an advertisement selected via the previously completed advertisement auction.

Based on an objective associated with the advertising campaign and the determined number of impressions, amount of reach, and budget associated with various bid amounts, the social networking system determines a bid amount for achieving an additional objective of the advertising campaign. For example, if an advertiser specifies an amount of reach for the advertising campaign, the social networking system determines a bid amount to present advertisements from the advertising campaign to a number of distinct users satisfying the amount of reach. As another example, the social networking system determines a budget for the advertising campaign based on the amounts charged to advertisers in previously completed advertisement auctions in which an advertisement associated with the determined bid amount would have been selected.

In another example, an advertiser specifies a budget for an advertising campaign, and the social networking system determines a bid amount to optimally use the specified budget based on previously completed advertisement auctions in which advertisements associated with various bid amounts would have been selected. In some embodiments, the social networking system determines a bid amount to increase the amount of reach of the advertising campaign based on previously completed advertisement auctions. For example, the social networking system determines a bid value that maximizes the reach of the advertising campaign without exceeding the specified budget based on previously completed advertisement auctions in which an advertisement from the advertising campaign would be selected when associated with different bid amounts. In addition, the social networking system may determine a maximum amount of reach for an advertising campaign within a specified budget based on previously completed advertisement auctions.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a block diagram of an advertisement module, in accordance with an embodiment.

FIG. 4 is example of information describing previously completed advertisement auctions and information predicting performance of an advertising campaign, in accordance with an embodiment.

FIG. 5 is an example of data associated with multiple selected bid amounts for an advertising campaign based on previously completed advertisement auctions, in accordance with an embodiment.

FIG. 6 is a flow chart of a method for predicting the performance of an advertising campaign, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

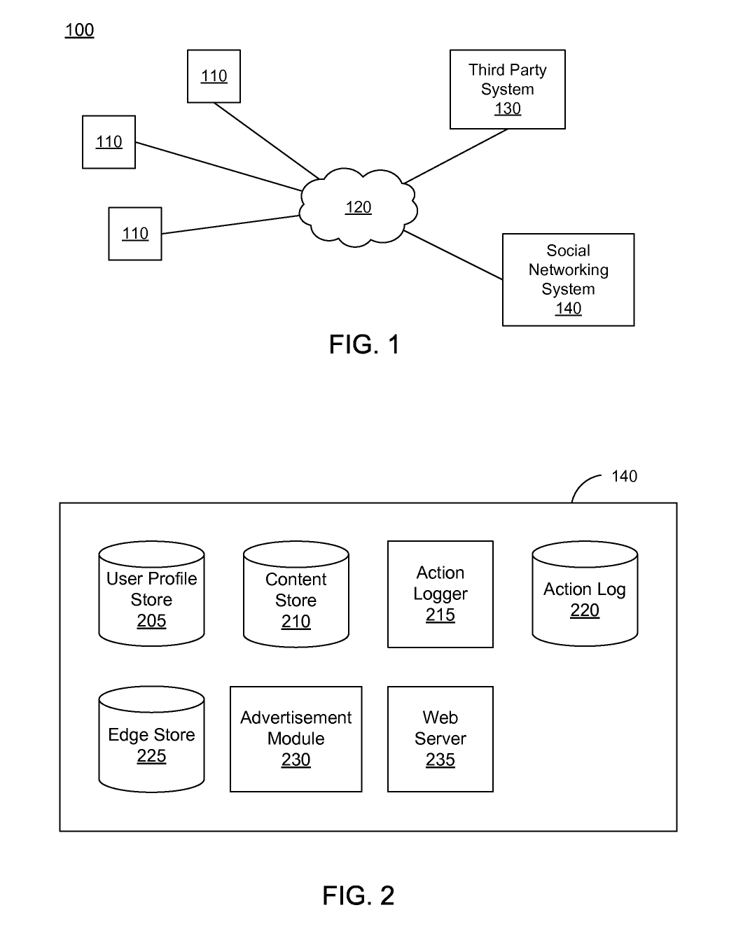

FIG. 1 is a block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. Further, the embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, an advertisement (“ad”) module 230, and a web server 235. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user2. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects in which each object may represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

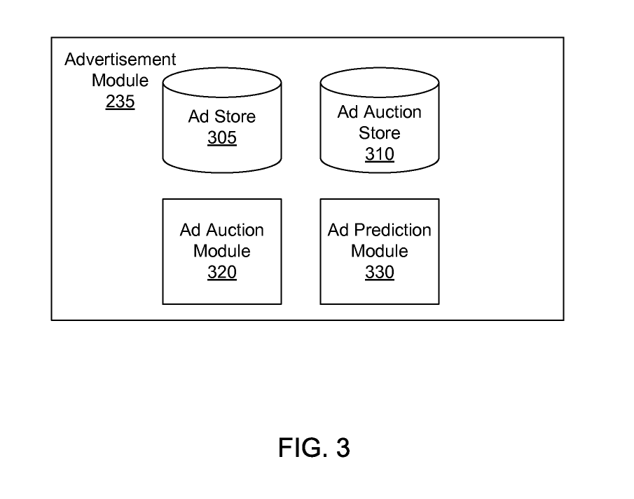

The ad module 230 is described with reference to FIG. 3, which is a block diagram of one embodiment of the ad module 230. In the example shown by FIG. 3, the ad module 230 includes an advertisement (“ad”) store 305, an ad auction store 310, an ad auction module 320, and an ad prediction module 330. The ad module 230 stores information describing advertisement (“ad”) campaigns received from one or more advertisers. Each advertising campaign includes one or more advertisements described by ad requests, with information describing an advertising campaign and its constituent advertisements included in the ad store 305.

An advertising campaign may be associated with one or more objectives, a duration, and a budget. An objective associated with an advertising campaign describes one or more goals for actions associated with the advertising campaign. For example, an objective specifies a total number of impressions of advertisements in the advertising campaign to social networking system users (an “impression objective”), specifies a total number of unique social networking system users to be presented with at least one advertisement from the advertising campaign (a “reach objective”), a number of times an advertisement from the advertising campaign is presented to a social networking system user (a “frequency objective”), or any other suitable criteria. The budget specifies a total amount of compensation an advertiser associated with an advertising campaign provides the social networking system 140 for presenting advertisements in the advertising campaign or for the social networking system 140 receiving interactions with advertisements in the advertising campaign. Additionally, the duration associated with the advertising campaign specifies a time interval during which advertisements from the advertising campaign are presented to social networking system users. For example, if the duration of an advertising campaign is 30 days, advertisements included in the advertising campaign are presented to social networking system users for 30 days after the advertising campaign is provided to the social networking system 140. In some embodiments, the advertiser may also specify a start date for the advertising campaign, so the duration is measured from the specified start date.

An advertising campaign includes one or more ad requests that each describe advertisements in the advertising campaign for presentation to one or more social networking system users. An ad request includes advertisement content, which is text, image, audio, video, or any other suitable data presented to a user. In various embodiments, the advertisement content is associated with a network address specifying a landing page, or other destination, to which a user is directed when the advertisement is accessed. An ad request also associates a bid amount with an advertisement. In some embodiments, the bid amount is specified by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

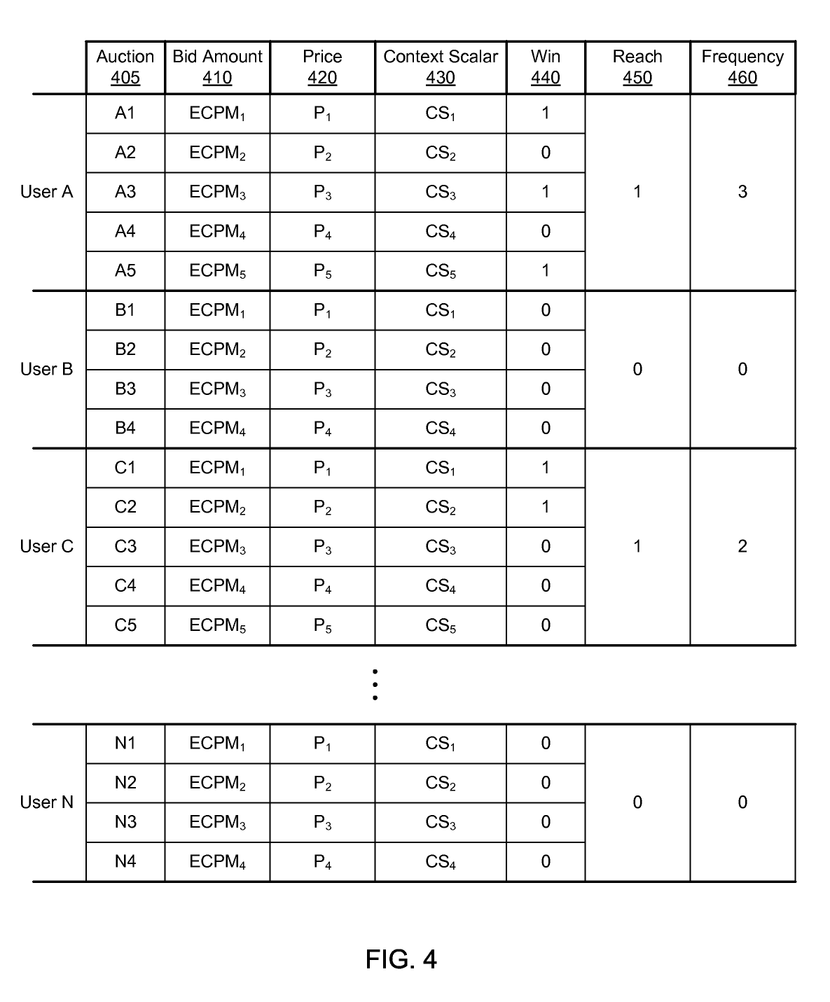

Alternatively, the advertiser does not associate a bid amount with the ad request, but specifies a budget, a duration and/or one or more objectives with an advertising campaign including the ad request. As further described below in conjunction with FIG. 4, the social networking system 140 determines a bid amount associated with the ad request based on the budget or one or more objectives associated with the advertising campaign including the ad request based on previously completed auctions selecting advertisements to a user. For example, based on a reach objective of an advertising campaign, the social networking system 140 analyzes previously completed advertisement auctions selecting an advertisement using different potential bid amounts to identify a bid amount for advertisements in the advertising campaign for accomplishing the reach objective.

Additionally, an ad request may include one or more targeting criteria specified by the advertiser. Targeting criteria included in an ad request specify one or more characteristics of users eligible to be presented with advertisement content associated with the ad request. For example, targeting criteria are used to identify users having user profile information, edges or actions satisfying at least one of the targeting criteria. Hence, targeting criteria allow an advertiser to identify users having specific characteristics, simplifying subsequent distribution of ad content to different users. Additionally, targeting criteria may be associated with an advertising campaign in its entirety, so multiple advertisements in the advertising campaign are eligible to users having characteristics satisfying one or more of the targeting criteria associated with the advertising campaign.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with ad content in an ad request that includes the targeting criteria. As another example, targeting criteria identifies users having a connection to another user or object or having a particular type of connection to another user or object.

The ad auction store 310 includes information describing previously completed auctions where one or more advertisements were selected. For example, the ad auction store 310 includes information identifying a user for which a previously completed auction selected an advertisement, the advertisement selected from the previously completed auction, a bid amount associated with the selected advertisement, an amount charged to an advertiser associated with the selected advertisement, and a context scalar describing a context in which the selected advertisement was presented based on an advertisement auction (e.g., based on the user, based on a location of ad placement, based on a type of computing device used to view the ad, and the like). In various embodiments, additional information describing an ad auction may also be stored, such as targeting criteria associated with the selected advertisement.

The ad auction module 320 retrieves advertisements from one or more advertising campaigns and ranks the received advertisements based on their associated bid amounts when an opportunity to present an advertisement to a user is identified. For example, the ad auction module 320 ranks the received advertisements based on their associated expected values, which are based at least in part on advertisements' bid amounts, where advertisements associated with larger expected values have a higher position in the ranking. The ad auction module 320 selects one or more advertisements based on the ranking, and the selected advertisements are presented to a social networking system user. For example, the ad auction module 320 selects advertisements having the highest position in the ranking or having at least a threshold position in the ranking. In other embodiments, the auction module 320 may use any other suitable method to select advertisements for presentation to a social networking system user.

The ad prediction module 330 predicts an expected performance of an advertisement based on information provided by the advertiser and information describing previously completed advertisement auctions retrieved from the ad auction store 310. In various embodiments, the ad prediction module 330 retrieves information from the ad auction store 310 describing previously completed advertisement auctions in which one or more advertisements were selected for presentation to a user. In an advertisement auction, advertisements are ranked based in part on bid amounts associated with each advertisement, and advertisements having at least threshold position in the ranking are selected for presentation to a social networking system user. For example, an expected value is determined for each advertisement in an advertisement auction based on the advertisements' bid amounts and likelihoods of user interaction with the advertisements; the advertisements are ranked based on their associated expected values, and one or more advertisements are selected for presentation based on the ranking. Advertisements from various advertising campaigns are typically included in an advertisement auction, so the likelihood of an advertisement from an advertising campaign being selected varies depending on the other advertisements included in the auction. For example, the ad prediction module 330 retrieves information from the ad auction store 310 describing advertisement auctions occurring within a time interval (e.g., one day) to estimate a number of impressions of advertisements from an advertising campaign and/or to estimate a number of different social networking system users to be presented with an advertisement from the advertising campaign during a subsequent time interval of the same duration as the time interval.

Information retrieved from the ad auction store 310 may account for targeting criteria associated with advertisements in the advertising campaign or associated with the adverstising campaign to identify previously completed advertisement auctions including advertisements with similar or matching targeting criteria. In some embodiments, the ad prediction module 330 determines an average number of opportunities to present an advertisement and/or the number of opportunities (i.e., advertisement auctions including advertisements with targeting criteria similar to or matching targeting criteria associated with the advertising campaign) to present an advertisement to a social networking system user that has not previously been presented with an advertisement from the advertising campaign over various time intervals. For example, the ad prediction module 330 determines the number of opportunities to present an advertisement to a social networking system user during each of the 10 days preceding a current date and determines an average value from the 10 days.

In some embodiments, the ad prediction module 330 determines the number of opportunities to present an advertisement or opportunities to present an advertisement to a social networking system user not previously presented with an advertisement from the ad campaign based on previously completed advertisement auctions during time periods having a common characteristic with a current time period. For example, if advertisements from an advertising campaign are to be presented on a Monday, the ad prediction module 330 determines the number of opportunities to present advertisements based on advertisement auctions completed on one or more prior Mondays. Example characteristics of a time period include: a day of the week, a month, a year, a holiday within a threshold time of a current time, or other similar data.

Based on the previously completed advertisement auctions retrieved from the ad auction store 310, the ad prediction module 330 associates various bid amounts with advertisements from an advertising campaign and identifies previously completed advertisement auctions in which an advertisement from the ad campaign would have been selected based on the various bid amounts. For example, the ad prediction module 330 identifies previously completed advertisement auctions in which an advertisement from the advertising campaign would have been selected for various bid amounts associated with the advertisement. This allows the ad prediction module 330 to identify a number of previously completed advertisement auctions in which the advertisement would have been selected when different bid amounts are associated with the advertisement. In one embodiment, the ad prediction module 330 determines whether a bid amount associated with an advertisement in the advertising campaign exceeded a bid amount associated with an advertisement selected from a previously completed auction (e.g., exceeded a maximum bid amount in the previously completed auction, exceeded a bid amount associated with an advertisement having at least a threshold position in a ranking from the previously completed auction, etc.). As further described below in conjunction with FIG. 4, in other embodiments, the ad prediction module 330 retrieves a context scalar associated with a previously completed advertisement auction and modifies a bid amount associated with the advertisement from the advertising campaign based on the context scalar; the ad auction prediction module determines if the modified bid amount associated with the advertisement from the advertising campaign would have been selected by the previously completed advertisement auction. In some embodiments, the ad prediction module 330 retrieves a set number of previously completed advertisement auctions. In other embodiments, the ad auction prediction module 315 retrieves each previously completed advertisement auction during a specified time period.

In one embodiment, the ad prediction module 330 also determines a number of opportunities to present advertisements corresponding to auctions in which an advertisement was selected for presentation to a user that had not previously been presented with an advertisement from an advertising campaign. This allows the ad prediction module 330 to identify a number of opportunities to present an advertisement to a user not previously presented with an advertisement. A number of the identified opportunities in which an advertisement from the advertising campaign would have been selected may then be determined to identify an estimated number of opportunities to present an advertisement from the advertising campaign to a user not previously presented with an advertisement from the advertising campaign. Similarly the ad prediction module 330 may identify from the information describing previously completed advertisement auctions opportunities to present an advertisement to social networking system users, users that had also been presented with another advertisement from an advertising campaign. This allows the ad prediction module 330 to identify a frequency with which advertisements from an advertising campaign are presented to various social networking system users.

The ad prediction module 330 determines a cost to an advertiser for presenting advertisements to users associated with the previously completed auctions in which an advertisement from the advertisement campaign would have been selected based on information describing previously completed advertisement auctions. In some embodiments, the ad auction prediction module 315 determines the average cost based on the amount of money charged by the social networking system 140 to an advertiser associated with an advertisement selected for presentation in a previously completed advertisement auction. The amount charged to an advertiser associated with an advertisement selected in a previously completed advertisement auction may be based on the bid amounts of other advertisements from the previously completed advertisement auction.

In some embodiments, the ad prediction module 330 determines the number of previously completed auctions in which an advertisement from the advertising campaign would have been selected, the number of opportunities to present advertisements corresponding to auctions in which an advertisement was selected for presentation to a user that had not previously been presented with an advertisement form the advertising campaign, and the average cost for presenting advertisements to users associated with the previously completed auctions in which an advertisement from the advertising campaign would have been selected for multiple bid amounts. For instance, the ad prediction module 330 may select multiple bid amounts with a set bid amount increment. In some embodiments, the ad prediction module 330 increases the bid amount until an advertisement from the advertising campaign would have been selected for every previously completed auction retrieved from the ad auction store 310.

Referring to FIG. 4, an example of information retrieved from the advertisement auction store 310 as well as information generated by the ad prediction module 330 from the information retrieved from the ad auction store 310 is shown. In the example of FIG. 4, information describing previously completed advertisement auctions for multiple users of the social networking system 140 is shown. In FIG. 4, identifiers 405 associated with various advertisement auctions for different users are maintained. A bid amount 410 associated with an advertisement request corresponding to an advertisement selected in a previously completed advertisement auction is identified and associated with an advertisement auction identifier 405. The bid amount 410 may be indicated as an expected cost per thousand impressions, or expected cost per mille, (ECPM) value. In some embodiments, previously completed advertisement auctions order and rank advertisement requests associated with advertisements participating in the advertisement auction based on bid amounts specified in the ad requests, and identify a maximum bid amount or a bid amount having a highest position in the ranking as the bid amount 410 of the advertisement selected via an advertisement auction. The bid amount 410 identified via the advertisement auction is stored in association with an identifier 405 associated with the advertisement auction. As shown in FIG. 4, the ad auction store 310 includes a bid amount 410 associated with an ad request selected for presentation from advertisement auctions completed for presenting advertisements to multiple users. For each of the users (e.g., users in a subset of users), the ad auction store 310 identifies a bid amount 410 from each ad request selected for presentation by various advertisement auctions completed for a user and associated an identified bid amount with an identifier 405 of an advertisement auction from which the ad request including the bid amount 410 was selected.

In various embodiments, the bid amount 410 associated with an ad request selected from an advertisement auction is a maximum bid amount associated with an ad request included in the advertisement auction. However, any suitable measure or numerical metric (e.g., any statistical measure such as or any variation of a central value, a median, a mean, a maximum value, within a specified range of a maximum value, a mode, or any other suitable measure) may be identified as the bid amount 410 associated with an ad request selected form the advertisement auction for a user. The bid amount 410 associated with an advertisement request selected from an advertisement auction for presentation to a user indicates how expensive it would be to an advertiser to present an advertisement to the user based on other advertisement requests that are also competing to reach the user in an advertisement auction, and conversely indicates whether an ad request with a specified bid value would be selected for presentation to a user given bid amounts associated with other ad requests for advertisements competing for presentation to the given user.

Additionally, a price 420 is associated with each identifier 405 of a completed advertisement auction. The price 420 specifies the amount charged to an advertiser associated with an ad request selected by the advertisement auction corresponding to the identifier 405 for presentation of the advertisement included in the selected ad request. In various embodiments, the price 420 is based at least in part on bid amounts associated with other ad requests included in the advertisement auction corresponding to the identifier 405. For example, the price 420 is determined based on bid amounts associated with one or more ad requests included in the advertisement auction that were not selected.

A context scalar 430 is also associated with a completed advertisement auction corresponding to an identifier 405. The context scalar is based on one or more attributes of the advertisement content in an ad request, one or more attributes of the user for which the advertisement auction was performed, a context (that defines a user-access condition, such as mobile, desktop, etc.) for presenting the advertisement content to the given user, or any combination thereof. In one embodiment, the context scalar 430 associated with the completed auction is a median or a mean of context scalars determined based on attributes of content of each advertisement included in the completed auction, so the context scalar 430 associated with the complete advertisement auction represents characteristics of multiple advertisements included in the completed advertisement auction. In some embodiments, the ad prediction module 330 normalizes a bid amount 410 associated with a completed advertisement auction by the context scalar 430 associated with the completed advertisement auction when comparing a bid amount associated with an advertisement to the bid amount 410 associated with the completed advertisement auction, as the context scalar 430 associated with the completed advertisement auction may boost or otherwise modify the bid amount 410 associated with the completed advertisement auction based on a presentation context (e.g., based on the user, based on a location of ad placement, based on a type of computing device used to view the ad, and the like).

Based on the retrieved bid amounts 410, prices 420, and context scalars 430 associated with various previously completed advertisement auctions, the ad prediction module 330 estimates performance of an advertising campaign or various advertisements for multiple bid amounts associated with the advertising campaign or with the advertisement. For example, the ad prediction module 430 retrieves a bid amount 410 and a context scalar 430 associated with an identifier 405 of a previously completed advertisement auction and selects a bid amount associated with an ad request including an advertisement from an advertising campaign. Based on the bid amount 410 associated with the previously completed advertisement auction, the selected bid amount associated with the ad request and the context scalar 430 associated with the previously completed advertisement auction, the ad prediction module 430 determines whether the ad request would have been selected in the previously completed advertisement auction when associated with the selected bid amount. In some embodiments, a context-based normalization is performed prior to the comparing the bid amount 410 associated with the previously completed advertisement auction and the bid amount selected for the ad request. For example, the bid amount 410 associated with the previously completed ad auction is divided or normalized by the context scalar 430 associated with the previously completed advertisement auction. The normalized bid amount 410 associated with the previously completed advertisement auction is then compared to the selected bid amount associated with the ad request to determine whether the ad request would have been selected in the previously completed advertisement auction when associated with the selected bid amount. Alternatively, the selected bid amount associated with the ad request is scaled by the context scalar 430 associated with the previously completed advertisement auction, and the scaled selected bid amount is compared to the bid amount 410 associated with the previously completed advertisement auction to determine whether the ad request would have been selected by the previously completed advertisement auction if associated with the selected bid amount.

For example, referring to FIG. 4, to determine if an ad request would have been selected in a previously completed advertisement auction associated with the identifier 405 A1 when associated with a selected bid amount, the selected bid amount associated with the ad request is compared to the bid amount 410, ECPM₁, associated with identifier A1. In some embodiments, the bid amount 410 associated with identifier A1 is normalized by the context scalar 430, CS₁, associated with identifier A1, and the selected bid amount associated with the ad request is compared to a normalized bid amount associated with identifier A1 (i.e., ECPM₁/CS₁ in FIG. 4). If bid amount is determined to exceed or be greater than the normalized bid amount associated with identifier A1, the ad prediction module 330 determines that the ad request would have been selected for presentation to User A in the auction associated with identifier A1 when associated with the selected bid amount. Alternatively, the selected bid amount is scaled by the context scalar 430 associated with identifier A1 and the scaled selected bid amount is compared to the bid amount 410 associated with identifier A1 to determine if the ad request would have been selected via the advertisement auction associated with identifier A1 when associated with the selected bid amount.

If the ad request would have been selected in the previously completed auction associated with identifier A1 when associated with the selected bid amount, the ad prediction module 330 stores an indication 440 that the ad request would have been selected in association with identifier A1. The indication 440 may be a binary value with a first value indicating the ad request would have been selected and a second value indicating the ad request would not have been selected. In some embodiments, if the ad request would not have been selected in the previously completed advertisement auction associated with identifier A1 when associated with the selected bid amount, an identifier 440 indicating the ad request would not have been selected is stored in association with identifier A1. As further described below in conjunction with FIG. 4, the ad prediction module 330 may associate multiple bid amounts with an ad request to identify previously completed auctions in which the ad request would have been selected for presentation when the ad request is associated with a different bid amount.

The ad auction prediction module 330 similarly determines if an ad request would have been selected in previously completed advertisement auctions for presenting advertisements to other users when associated with a selected bid amount. In the example of FIG. 4, if the selected bid amount is determined to be less than ECPM₁/CS₁ for the previously completed advertisement auction associated with identifier B1 for User B, the ad prediction module 330 determines that the ad request would not have been selected for presentation to User B in the previously completed advertisement auction associated with identifier B1 when associated with the selected bid amount. Similarly, in the example of FIG. 4, the selected bid amount associated with the ad request is less than ECPM₂/CS₂ (for previously completed auction associated with identifier B2) for User B, to be less than ECPM₃/CS₃ (for previously completed auction associated with identifier B3) for User B, and ECPM₄/CS₄ (for previously completed auction associated with identifier B4) for User B. Thus, the ad request is not selected for presentation in the previously completed advertisement auctions for presentation to User B.

If the ad prediction module 330 determines an ad request would have been selected for presentation to a user in a previously completed advertisement auction, the ad prediction module 330 associates an impression of the ad request with the previously completed advertisement auction. In the example of FIG. 4, when associated with a selected bid amount, the ad prediction module determines that the ad request would have been selected in for previously completed auctions associated with identifiers A1, A3, and A5 for User A. The ad prediction module 330 determines if another advertisement from the advertising campaign including the ad request was presented to User A before completion of the previously completed auction associated with identifiers A1, A3, and A5. If an advertisement from the advertising campaign including the ad request was not presented to User A before completion of the previously completed auction associated with identifiers A1, A3, and A5, the ad prediction module 330 associates a reach count 450 with User A. In some embodiments, the reach count is a binary count. For instance, if an ad request would have been selected in previously completed auctions associated with a specific user, the reach count for the specific user is set to 1. Otherwise, if an ad request would not have been selected in previously completed auctions associated with the specific user, the reach count of the specific user is set to 0. Conversely, in the example of FIG. 4, the ad request would not have been selected for presentation to User B in the previously completed advertisement auctions associated with User B, a reach count 450 is not associated with User B.

Additionally, the ad prediction module 330 retrieves a price 420 associated with one or more of the previously completed advertisement auctions. The price 420 associated with an advertisement auction specifies the amount the social networking system 140 charges an advertiser associated with the advertisement selected via the previously completed advertisement auction. In one embodiment, the ad prediction module 330 retrieves prices 420 associated with previously completed advertisement auctions in which an ad request associated with a selected bid amount would have been selected. Alternatively, the ad prediction module 330 retrieves prices 420 associated with each previously completed advertisement auction.

In some embodiments, a reach count 450 is associated with distinct users of the social networking system 140 if the ad request would have been selected in at least one previously completed advertisement for presenting advertisements to a social networking system user not previously presented with an advertisement from the same advertising campaign as the ad request. Conversely, a reach count 450 is not associated with a user if the ad request would not have been selected in at least one previously completed advertisement auction associated with the user when associated with a bid amount. Further, a reach count 450 is not associated with a user if the user was previously presented with an advertisement from the same advertising campaign. While FIG. 4 shows indications 440 of impressions and reach counts 450 as numerical values, any suitable value may be used. For example, indications 440 of impressions or reach counts 450 may be represented using a logic or Boolean value, capable of being set to true or false, a string or alphanumeric value; or any other suitable measure of expected reach

In some embodiments, the ad prediction module 330 records a frequency count 460 with each user. The frequency count 460 indicates a number of previously completed advertisement auctions for presenting advertisements to a specific user in which an ad request associated with an advertising campaign would have been selected for presentation to the specific user when associated with a selected bid amount. In the example of FIG. 4, an ad request including an advertisement from an advertising campaign would have been selected in auctions A1, A3 and A5 for User A. Thus, a frequency count 460 of 3 is recorded for User A. Similarly, in FIG. 4, an advertisement from the advertising campaign would have been selected in auctions C1 and C2 of User C, so a frequency count 460 of 2 is associated with User C.

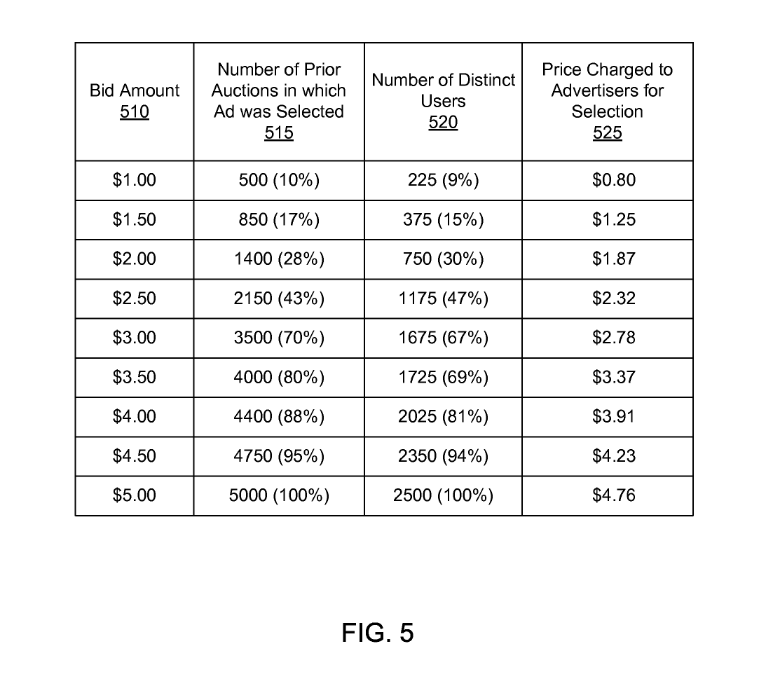

The ad prediction module 330 associates different selected bid amounts with one or more ad requests from an advertising campaigns and determines indications of impressions, reach counts, prices, and/or frequency counts as described above in conjunction with FIG. 5 based on the different selected bid amounts associated with the one or more ad requests. Based on the indications of impressions, reach counts, prices, and/or frequency counts, the ad prediction module 330 generates information describing an expected performance of an ad request or an advertising campaign for multiple selected bid amounts. FIG. 5 shows an example of data associated with multiple selected bid amounts by the ad prediction module 330. In the example of FIG. 5, a table identifies various bid amounts 510 associated with ad requests from an advertising campaign.

For each bid amount 510, the table in FIG. 5 associates a bid amount with a number 515 of previously completed advertisement auctions in which an ad request associated with a bid amount 510 would have been selected for presentation to a user, with a number 520 of distinct users to which the ad request associated with the bid amount 510 would have been presented in the previously completed auctions, and with a price 525 to an advertiser for presentation of an advertisement included in the ad request associated with the bid amount 510. The number 515 of previously completed advertisement auctions is determined from the indications 440 of impressions of an ad request associated with a bid amount 510 as described above in conjunction with FIG. 4, while the number 520 of distinct users is determined from the reach count 450 described above in conjunction with FIG. 4. The price 525 is determined from the prices 420 charged to an advertiser in previously completed advertisement auctions in which an ad request associated with a bid amount 510 would have been selected. For example, the price 525 associated with a bid amount 510 is an average of prices 420 charged to the advertiser in various previously completed advertisement auctions in which an advertisement associated with the bid amount 510 would have been selected. However, in other embodiments, the price 525 associated with a bid amount 510 may be determined from the prices 420 charged to an advertiser in various previously completed advertisement auctions in which an ad request associated with the bid amount 510 would have been selected using any suitable method.

As shown in FIG. 5, larger bid amounts 510 are associated with an increased number 515 of previously completed advertisement auctions in which an ad request associated with a bid amount 510 would have been selected. Additionally, an increased number 520 of distinct users may be associated with larger bid amounts 510. Increasing bid amounts 510 may also result in increasing the price 525 charged to an advertiser for presentation of an ad request associated with a bid amount 510. For example, associating a bid amount of $1.00 with an ad request from an advertising campaign results in an advertisement included in the ad request being selected 500 times in previously completed advertisement auctions, being presented to 225 distinct users, and an advertiser being charged a price of $0.80. If the bid amount associated with the ad request is increased to $3.00, the advertisement included in the ad request would have been selected 3500 times in previously completed advertisement auctions; in this example, the increased number of impressions causes the advertisement to be presented to 1675 distinct users and the advertiser to be charged a price of $2.75.

Based on the information associated with various bid amounts from the previously completed auctions and an objective associated with an advertising campaign, the ad prediction module 330 may determine a value of an additional objective for the advertising campaign. For example, if a budget is specified for an advertising campaign, the ad prediction module 330 determines an estimated number of distinct users to which one or more advertisements from the advertising campaign are presented.

The ad prediction module 330 determines an estimated number of distinct users to which an advertisement from the advertising campaign would be presented, based on a budget associated with the advertising campaign and the information associated with various bid amounts based on previously completed advertising auctions. In one embodiment, the ad prediction module 330 determines a total amount charged to an advertiser based on the price charged to an advertiser for selection of an advertisement associated with a bid amount and the number of previously completed advertisement auctions in which an ad request associated with the bid amount would have been selected. For example, the ad prediction module 330 determines a total amount charged to an advertiser as a product of a number of previously completed advertisement auctions in which an advertisement associated with a bid amount would have been selected and a price charged to the advertiser for selection of an ad request associated with the bid amount. In one embodiment, the ad prediction module 330 identifies multiple bid amounts associated with a total amount charged to the advertiser that does not exceed the budget associated with the advertising campaign and a number of distinct users to which an advertisement from the advertising campaign would have been presented if associated with each bid amount combined prices charged to an advertiser for selection of an advertisement from the advertising campaign. Alternatively, the ad prediction module 330 determines a bid amount associated with an ad request that results in a maximum total amount charged to the advertiser that does not exceed the budget associated with the advertising campaign and identifies the number of distinct users to which an advertisement from the advertising campaign associated with the determined bid amount would have been presented.

Referring to the example of FIG. 5, if an advertiser associates a budget of $10,000 with an advertising campaign, the ad prediction module 330 determines a total amount charged to the advertiser for different bid amounts and identifies a bid amount associated with a maximum number of distinct users presented with an advertisement from the advertising campaign. In the example of FIG. 5, a bid amount of $3.00 results in a total amount charged to the advertiser of ($2.78)(3500), or $9700, which is the maximum total amount charged to the advertiser that does not exceed the budget associated with the advertising campaign. The ad prediction module 330 identifies to the advertiser the number of distinct users to which an advertisement associated with the budget bid amount of $3.00, which is 1675 distinct users in FIG. 5.

In some embodiments, ad prediction module 330 adjusts the number 515 of previously completed advertisement auctions in which an advertisement for the advertising campaign associated with a bid amount 510 would have been selected based on a predicted number of users accessing the social networking system 140 during the period of time the advertising campaign is being run. For example, a percentage of previously completed advertisement auctions in which an advertisement from the advertising campaign included in an ad request associated with a specific bid amount would have been selected is determined based on the total number of previously completed advertisement auctions and the number of previously completed advertisement auctions in which an advertisement from the advertising campaign would have been selected. This percentage of previously completed advertisement auctions may be used to estimate a number of predicted advertisement auction in which an advertisement included in an ad request having a specific bid amount would have been selected.

As another example, the ad prediction module 330 determines a budget for an advertising campaign based on a reach objective associated with the advertising campaign and information associated with various bid amounts based on previously completed advertisement auctions. In one embodiment, the ad prediction module 330 identifies a bid amount associated with a number of distinct users that would be presented with an advertisement associated with the bid amount that is within a threshold amount of the reach objective. The ad prediction module 330 determines a budget for the advertiser based on a price charged to an advertiser associated with the identified bid amount and a number of previously completed advertisement auctions in which an advertisement associated with the identified bid amount would have been selected. For example the budget is determined as a product of the price charged to the advertiser associated with the identified bid amount and the number of previously completed advertisement auctions in which an advertisement associated with the identified bid amount would have been selected.

In another example, based on a budget and a reach objective associated with an advertising campaign, the ad prediction module 330 determines a bid amount for one or more ad requests including advertisements from the advertising campaign based on previously completed advertisement auctions. A bid amount associated with a number of distinct users that would have been presented with an advertisement associated with the bid amount within a threshold amount of the reach objective and also associated with a price charged to the advertiser that does not exceed the budget is identified. As described above, the price charged to the advertiser is based on the price charged to the advertiser associated with the bid amount and a number of previously presented advertisement auctions in which an advertisement associated with the bid amount would have been selected.

The web server 235 links the social networking system 140 via the network 120 to the one or more client devices 110, as well as to the one or more third party systems 130. The web server 235 serves web pages, as well as other content, such as JAVA®, FLASH®, XML and so forth. The web server 234 may receive and route messages between the social networking system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

### Determining Reach or Budget for an Advertising Campaign

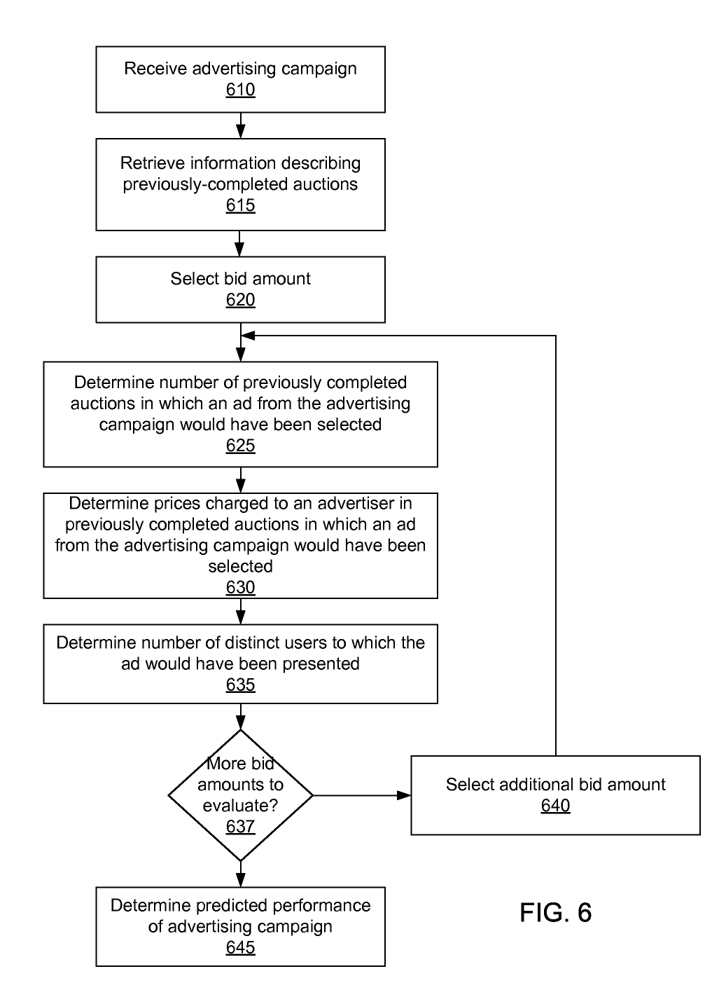

FIG. 6 is a flowchart of one embodiment of method for determining an objective of an advertising campaign. In various embodiments, the steps described in conjunction with FIG. 6 may be performed in different orders. Additionally, different and/or additional steps than those described in conjunction with FIG. 6 may be performed in some embodiments.

The social networking system 140 receives 610 an advertising campaign including one or more ad requests including advertisements for presentation to social networking system users. The advertising campaign is associated with a duration, one or more objectives, and one or more targeting criteria. An objective of an advertising campaign describes one or more goals for actions associated with the advertising campaign. For example, an objective specifies a total number of impressions of advertisements in the advertising campaign to social networking system users (an “impression objective”), specifies a total number of unique social networking system users to be presented with at least one advertisement from the advertising campaign (a “reach objective”). Additionally, the advertising campaign may be associated with budget specifying an amount of compensation an advertiser associated with the advertising campaign will provide the social networking system 140 for presenting advertisements in the advertising campaign. In some embodiments, the advertising campaign is associated with an objective but not a budget or is associated with a budget but not an objective. The social networking system 140 may determine a budget based on an objective associated with the advertising campaign or may determine an objective associated with the advertising campaign based on the budget associated with the advertising campaign.

The social networking system retrieves 615 information describing previously completed advertisement auctions in which one or more advertisements were selected for presentation to social networking system users. As described above in conjunction with FIG. 3, the retrieved information may identify previously completed auctions that occurred over a length of time matching an interval determined from the advertising campaign's duration. Additionally, information describing previously completed auctions may identify previously completed auctions including advertisements included in ad requests having targeting criteria matching or similar to targeting criteria associated with ad requests in the received advertising campaign or associated with the received advertising campaign. A number of the identified previously completed auctions may also be determined to specify a total number of opportunities to present advertisements to social networking system users corresponding to the previously completed auctions.

In some embodiments, the retrieved 615 information is limited to information describing previously completed advertisement auctions for presenting advertisements to social networking system users having characteristics satisfying at least a threshold number of targeting criteria associated with the advertising campaign. For instance, an advertising campaign may be associated with targeting criteria to identify users who live in Texas and have indicated a preference for topics of “Technology,” “Computers,” or “Information Technology.” Information describing previously completed advertising auctions for presenting advertisements to users who live in Texas and who indicated a preference for at least one of the identified topics is retrieved 615. In some embodiments, information describing previously completed advertisement auctions for a subset of users eligible to be presented with an advertisement from the advertising campaign is retrieved 615. For example, users eligible to be presented with an advertisement from the advertising campaign are sampled at a sampling rate of 1/M, so information describing previously completed advertisement auctions for every Mth user eligible to be presented with an advertisement from the advertising campaign is retrieved 615. Alternatively or additionally, a size of the selected subset of users eligible to be presented with an advertisement from the advertising campaign is determined to be greater than a threshold sample size. For example, at least 10% of the users of the users eligible to be presented with an advertisement from the advertising campaign target population are sampled. This limits the information about previously completed advertisement auctions to those advertisement auctions involving social networking system users eligible to be presented with an advertisement from the advertising campaign. Alternatively, the social networking system retrieves 615 information describing a specified number of recently completed advertisement auctions (e.g., for the 100 most recent completed auctions) or describing a specified number of previously completed advertisement auctions.

The social networking system 140 selects 620 a bid amount. In some embodiments, the selected bid amount is a preset value (e.g., $0.50). Alternatively, the bid amount is selected 620 based on the one or more objectives associated with the advertising campaign. For example, a bid amount is selected 620 based on a reach objective or a based on a budget associated with the advertising campaign.

Based on the selected bid amount, the social networking system 140 determines 625 a number of previously completed advertisement auctions in which an advertisement from the advertising campaign included in an ad request associated with the selected bid amount would have been selected is determined. For example, the social networking system 140 determines 625 whether an advertisement included in an ad request associated with the selected bid amount would have been selected in each of the retrieved previously completed advertisement auctions. For example, the social networking system 140 identifies a number of previously completed advertisement auctions in which the selected bid amount exceeds a bid amount associated with an advertisement selected by a previously completed auction (e.g., exceeded a maximum bid amount in the previously completed advertisement auction, exceeded a bid amount associated with an advertisement having at least a threshold position in a ranking from the previously completed advertisement auction, etc.).

In other embodiments, the selected bid amount or a bid amount associated with a previously completed advertisement auction is modified by a context scalar associated with the previously completed advertisement auction. As described above in conjunction with FIG. 4, a context scalar represents presentation contexts for an advertisement selected by the previously completed advertisement auction. Various factors may be used to determine a context scalar, such as one or more attributes of the advertisement content, one or more attributes of the given user, a context (that defines a user-access condition, such as mobile, desktop, etc.) for presenting the advertisement content to the given user, or any combination thereof. In one embodiment, the selected bid amount is scaled by the context scalar associated with a previously completed advertisement and the scaled selected bid amount is compared to the bid amount associated with the previously completed advertisement auction. If the scaled selected bid amount is greater than the bid amount associated with the previously completed advertisement auction, the previously completed advertisement auction is identified as an advertisement auction in which the selected bid amount would have been selected. Alternatively, a bid amount associated with the a previously completed advertisement auction is divided by the context scalar associated with the previously completed advertisement auction; if the selected bid amount is greater than the result of the division, the previously completed advertisement auction is identified as an advertisement auction in which the selected bid amount would have been selected.

For each of the previously completed auctions in which an advertisement from the advertising campaign included in an ad request associated with the selected bid amount would have been selected, a price charged to an advertiser for presenting the advertisement is determined 630. For example, the price is determined 630 based on the amount of money paid to the social networking system 140 by advertisers associated with an advertisement selected in each previously completed advertisement auctions in which an advertisement associated with the selected bid amount would have been selected. For example, the price charged to the advertiser is determined 630 as an average of the prices charged to advertisers in previously completed advertisement auctions in which an advertisement associated with the selected bid amount would have been selected. Further, as described above in conjunction with FIGS. 4 and 5, the social networking system determines 635 a number of distinct users to which an advertisement from the advertising campaign would be presented based on the selected bid amount based on the users associated with the previously completed advertisement auctions.

In some embodiments, an advertiser specifies a frequency cap for the advertising campaign. The frequency cap limits the number of times an advertisement from the advertising campaign is shown to a user of the social networking system 140. For instance, if an advertiser from the advertising campaign specifies a frequency cap of 3, an advertisement from the advertising campaign would be presented to a specific user of the social networking system at most three times during the length of the advertising campaign. If the user has already been presented with advertisements from the advertising campaign a number of times equal to the frequency cap, advertisements from the advertising campaign are not included in auctions for presenting advertisements to the user.

The frequency cap may be used to determine a number of impressions, a budget, and/or reach objective for an advertising campaign. For example, when determining a total number of impressions capable of being achieved with the selected bid amount, the social networking system 140 may limit the number of previously completed advertisement auctions for presenting an advertisement to a user in which an advertisement associated with the selected bid amount identified based on the frequency cap. For example, the social networking system 140 may determine that with the selected bid amount, the advertising campaign would have won five of the previously completed auctions. If the frequency cap is 3, the social networking system 140 determines 625 that three previously completed advertisement auctions for presenting an advertisement to the specific user would have selected an advertisement included in an ad request associated with the selected bid amount, as the total number of advertisement auctions that would have been won by the advertising campaign included in an ad request associated with the selected bid amount would have been selected is greater than the specified frequency cap.

In various embodiments, the social networking system 140 determines 637 if there are more bid amounts to evaluate. For example, the social networking system 140 determines 637 if at least a threshold number of bid amounts have been evaluated. If there are more bid amounts to evaluate, an additional bid amount may be selected 640 by the social networking system 140, which then determines 625 a number of previously completed advertisement auctions in which an advertisement included in an ad request associated with the additional bid amount would have been selected, determines 630 prices charged to advertisers in previously completed advertisement auctions in which an advertisement included in an ad request associated with the additional bid amount would have been selected, and determines 635 a number of distinct users that would have been presented with an advertisement included in an ad request associated with the additional bid amount as described above. In some embodiments, the additional bid amount is the current bid amount incremented by a specified value (e.g., the currently selected bid amount plus $0.50). In some embodiments, the social networking system 140 increases the bid amount, and evaluates the increased bid amounts as described above until an advertisement from the advertising campaign would have been selected at least a threshold number of previously completed advertisement auctions.

Based on the determined numbers of previously completed auction in which an ad from the advertising campaign would have been selected when included in ad requests associated with different bid amounts, the social networking system 140 determines 645 the predicted performance of the advertising campaign for the different bid amounts. For example, the determined predicted performance is the information described above in conjunction with FIG. 5. Based on the predicted performance of the advertising campaign for various bid amounts and information associated with the advertising campaign, the social networking system 140 may determine a budget or one or more objectives for the advertising campaign. For example, as described above in conjunction with FIG. 3, the social networking system 140 determines a budget for the advertising campaign based on a reach objective associated with the advertisement and the predicted performance of the advertising campaign for various bid amounts. As another example, also discussed above in conjunction with FIG. 3, the social networking system 140 determines a predicted amount of reach for the advertising campaign based on a budget associated with the advertising campaign and the predicted performance of the advertising campaign for various bid amounts.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information for an advertising campaign including one or more advertisements for presentation to one or more users of a social networking system, the advertising campaign associated with one or more targeting criteria;
retrieving information describing previously completed advertisement auctions that each selected an advertisement for presentation to a user of the social networking system associated with characteristics satisfying one or more of the targeting criteria, the retrieved information including bid amounts of advertisements selected in the previously completed advertisement auctions and a charged price associated with each advertisement selected in a previously completed advertisement auction; and
for a plurality of bid amounts,
selecting a bid amount from the plurality of bid amounts;
determining, by a processor, a number of the previously completed advertisement auctions in which an advertisement from the advertising campaign associated with the selected bid amount would have been selected, based at least in part on the retrieved information and the selected bid amount,
storing the selected bid amount in association with the number of previously completed advertisements in which the advertisement from the advertising campaign associated with the selected bid amount would have been selected.

2. The method of claim 1, further comprising:
for the plurality of bid amounts,
determining a price charged in each of the previously completed advertisement auctions in which the advertisement from the advertising campaign associated with the selected bid amount would have been selected based at least in part on the retrieved information;
determining a number of distinct users to whom previously completed advertisement auctions in which the advertisement from the advertising campaign associated with the selected bid amount would have been selected, based at least in part on the retrieved information and the selected bid amount; and
storing the price charged in each previously completed advertisement auctions in which the advertisement from the advertising campaign with the selected bid amount would have been selected, and the number of distinct users.

3. The method of claim 2, wherein the received information for the advertising campaign includes a budget associated with the advertising campaign.

4. The method of claim 3, further comprising:
determining a maximum number of distinct users for which one or more advertisement from the advertising campaign would have been selected based at least in part on the determined prices associated with each bid amount from the plurality of bid amounts, the number of distinct users to whom previously completed advertisement auctions in which the advertisement from the advertising campaign associated with each bid amount would have been selected, and the budget associated with the advertising campaign.

5. The method of claim 4, wherein determining the maximum number of distinct users comprises:
identifying a bid amount from the plurality of bid amounts associated with a maximum value for a total amount charged that does exceed the budget, the total amount charged based at least in part on the determined price charged associated with identified bid amount and the number of the previously completed advertisement auctions in which the advertisement from the advertising campaign associated with the identified bid amount would have been selected; and
determining the maximum number of distinct users as the number of distinct users to whom previously completed advertisement auctions in which one or more advertisements from the advertising campaign associated with identified bid amount would have been selected.

6. The method of claim 2, wherein the received information for the advertising campaign includes a reach objective specifying a number of distinct users to be presented with one or more advertisements from the advertising campaign.

7. The method of claim 6, further comprising:
determining a budget for the advertising campaign based at least in part on the determined prices charged associated with each bid amount from the plurality of bid amounts, the number of distinct users to whom previously completed advertisement auctions in which the advertisement from the advertising campaign associated with each bid amount would have been selected, the number of the previously completed advertisement auctions in which the advertisement from the advertising campaign associated with the identified bid amount would have been selected, and the reach objective.

8. The method of claim 7, wherein determining the budget for the advertising campaign comprises:
identifying a bid amount from the plurality of bid amounts associated a number of distinct users to whom previously completed advertisement auctions in which the advertisement from the advertising campaign associated with the bid amount from the plurality of bid amounts would have been selected that is within a threshold amount of the reach objective; and
determining the budget based at least in part on the determined price charged associated with identified bid amount and the number of the previously completed advertisement auctions in which the advertisement from the advertising campaign associated with the identified bid amount would have been selected.

9. The method of claim 8, wherein determining the budget based at least in part on the determined price charged associated with the identified bid amount and the number of the previously completed advertisement auctions in which the advertisement from the advertising campaign associated with the identified bid amount would have been selected comprises:
determining a product of the price charged associated with the identified bid amount and the number of the previously completed advertisement auctions in which the advertisement from the advertising campaign associated with the identified bid amount would have been selected as the budget.

10. The method of claim 2, wherein determining the number of the previously completed advertisement auctions in which an advertisement from the advertising campaign associated with the selected bid amount would have been selected, based at least in part on the retrieved information and the selected bid amount comprises:
retrieving a context scalar associated with each of the previously completed advertisement auctions from the retrieved information, the context scalar describing a context in which an advertisement selected by a previously completed advertisement auction was presented;
modifying bid amounts associated with each of the previously completed advertisement auctions based at least in part on the retrieved context scalars; and
determining a number of the previously completed advertisement auctions in which the selected bid amount is greater than a modified bid amount associated with the previously completed advertisement auction.

11. The method of claim 2, wherein the received information for the advertising campaign further includes a frequency cap, and wherein determining the number of the previously completed advertisement auctions in which the advertisement from the advertising campaign associated with the selected bid amount would have been selected comprises:
identifying users associated with each of the previously completed advertisement auctions in which the advertisement from the advertising campaign associated with the selected bid amount would have been selected;
determining a number of the previously completed advertisement auctions in which the advertisement form the advertising campaign associated with the selected bid amount would have been selected associated with each identified user; and
associating a number of previously completed advertisement auctions in which the advertisement with the advertising campaign would have been selected equal to the frequency cap with a user associated with a number of previously completed advertisement auctions in which the advertisement with the advertising campaign that exceeds the frequency cap.

12. The method of claim 2, wherein determining the price charged in each of the previously completed advertisement auctions in which the advertisement from the advertising campaign associated with the selected bid amount would have been selected based at least in part on the retrieved information comprises:
determining an average price charged based on prices charged in each in each of the previously completed advertisement auctions in which the advertisement from the advertising campaign associated with the selected bid amount would have been selected.

13. A computer program product comprising a non-transitory computer readable storage medium having instructions encoded thereon that, when executed by a processor, cause the processor to:
receive information for an advertising campaign including one or more advertisements for presentation to one or more users of a social networking system, the advertising campaign associated with one or more targeting criteria;
retrieve information describing previously completed advertisement auctions that each selected an advertisement for presentation to a user of the social networking system associated with characteristics satisfying one or more of the targeting criteria, the retrieved information including bid amounts of advertisements selected in the previously completed advertisement auctions and a charged price associated with each advertisement selected in a previously completed advertisement auction; and
for a plurality of bid amounts,
select a bid amount from the plurality of bid amounts;
determining a number of the previously completed advertisement auctions in which an advertisement from the advertising campaign associated with the selected bid amount would have been selected, based at least in part on the retrieved information and the selected bid amount,
determine a price charged in each of the previously completed advertisement auctions in which the advertisement from the advertising campaign associated with the selected bid amount would have been selected based at least in part on the retrieved information; and
determine a number of distinct users to whom previously completed advertisement auctions in which the advertisement from the advertising campaign associated with the selected bid amount would have been selected, based at least in part on the retrieved information and the selected bid amount; and
store the selected bid amount in association with the number of previously completed advertisements in which the advertisement from the advertising campaign associated with the selected bid amount would have been selected, the price charged in each previously completed advertisement auctions in which the advertisement from the advertising campaign associated with the selected bid amount would have been selected, and the number of distinct users.

14. The computer program product of claim 13, wherein the non-transitory computer readable storage medium further has instructions encoded thereon that, when executed by the processor, cause the processor to:
for the plurality of bid amounts,
determine a price charged in each of the previously completed advertisement auctions in which the advertisement from the advertising campaign associated with the selected bid amount would have been selected based at least in part on the retrieved information; and
determine a number of distinct users to whom previously completed advertisement auctions in which the advertisement from the advertising campaign associated with the selected bid amount would have been selected, based at least in part on the retrieved information and the selected bid amount; and
store the price charged in each previously completed advertisement auctions in which the advertisement from the advertising campaign associated with the selected bid amount would have been selected, and the number of distinct users.

15. The computer program product of claim 14, wherein the received information for the advertising campaign includes a budget associated with the advertising campaign.

16. The computer program product of claim 15, wherein the non-transitory computer readable storage medium further has instructions encoded thereon that, when executed by the processor, cause the processor to:
determine a maximum number of distinct users for which one or more advertisement from the advertising campaign would have been selected based at least in part on the determined prices associated with each bid amount from the plurality of bid amounts, the number of distinct users to whom previously completed advertisement auctions in which the advertisement from the advertising campaign associated with each bid amount would have been selected, and the budget associated with the advertising campaign.

17. The computer program product of claim 16, wherein determine the maximum number of distinct users comprises:
identify a bid amount from the plurality of bid amounts associated with a maximum value for a total amount charged that does exceed the budget, the total amount charged based at least in part on the determined price charged associated with identified bid amount and the number of the previously completed advertisement auctions in which the advertisement from the advertising campaign associated with the identified bid amount would have been selected; and
determine the maximum number of distinct users as the number of distinct users to whom previously completed advertisement auctions in which one or more advertisements from the advertising campaign associated with identified bid amount would have been selected.

18. The computer program product of claim 14, wherein the received information for the advertising campaign includes a reach objective specifying a number of distinct users to be presented with one or more advertisements from the advertising campaign.

19. The computer program product of claim 18, wherein the non-transitory computer readable storage medium further has instructions encoded thereon that, when executed by the processor, cause the prossor to:
determine a budget for the advertising campaign based at least in part on the determined prices charged associated with each bid amount from the plurality of bid amounts, the number of distinct users to whom previously completed advertisement auctions in which the advertisement from the advertising campaign associated with each bid amount would have been selected, the number of the previously completed advertisement auctions in which the advertisement from the advertising campaign associated with the identified bid amount would have been selected, and the reach objective.

20. The computer program product of claim 19, wherein determine the budget for the advertising campaign comprises:
identify a bid amount from the plurality of bid amounts associated a number of distinct users to whom previously completed advertisement auctions in which the advertisement from the advertising campaign associated with the bid amount from the plurality of bid amounts would have been selected that is within a threshold amount of the reach objective; and
determine the budget based at least in part on the determined price charged associated with identified bid amount and the number of the previously completed advertisement auctions in which the advertisement from the advertising campaign associated with the identified bid amount would have been selected.

21. The computer program product of claim 20, wherein determine the budget based at least in part on the determined price charged associated with the identified bid amount and the number of the previously completed advertisement auctions in which the advertisement from the advertising campaign associated with the identified bid amount would have been selected comprises:
determine a product of the price charged associated with the identified bid amount and the number of the previously completed advertisement auctions in which the advertisement from the advertising campaign associated with the identified bid amount would have been selected as the budget.

22. The computer program product of claim 14, wherein determine the price charged in each of the previously completed advertisement auctions in which the advertisement from the advertising campaign associated with the selected bid amount would have been selected based at least in part on the retrieved information comprises:
determine an average price charged based on prices charged in each in each of the previously completed advertisement auctions in which the advertisement from the advertising campaign associated with the selected bid amount would have been selected.

23. A system comprising:
a processor; and
a non-transitory computer readable storage medium having instructions encoded thereon that, when executed by the processor, cause the processor to:
receive information for an advertising campaign including one or more advertisements for presentation to one or more users of a social networking system, the advertising campaign associated with one or more targeting criteria;
retrieve information describing previously completed advertisement auctions that each selected an advertisement for presentation to a user of the social networking system associated with characteristics satisfying one or more of the targeting criteria, the retrieved information including bid amounts of advertisements selected in the previously completed advertisement auctions and a charged price associated with each advertisement selected in a previously completed advertisement auction; and
for a plurality of bid amounts,
select a bid amount from the plurality of bid amounts;
determining a number of the previously completed advertisement auctions in which an advertisement from the advertising campaign associated with the selected bid amount would have been selected, based at least in part on the retrieved information and the selected bid amount; and
store the selected bid amount in association with the number of previously completed advertisements in which the advertisement from the advertising campaign associated with the selected bid amount would have been selected.
